(19) United States
(12) Patent Application Publication
(10) Pub. No.: US 2008/0320524 A1
(43) Pub. Date: Dec. 25, 2008

(54) INFORMATION SELECTION APPARATUS AND INFORMATION SELECTION METHOD

(76) Inventor: Kiyoshi Sakamoto, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/144,311

(22) Filed: Jun. 23, 2008

(30) Foreign Application Priority Data
Jun. 25, 2007 (JP) 2007-166631

(51) Int. Cl. G06F 3/00

(52) U.S. Cl. 725/52

(57) ABSTRACT

Of one embodiment, an information selection screen including a plurality of selection areas is divided into a predetermined number of groups each having an identical number of selection areas. One group is selected from the divided groups by use of selection keys arranged to correspond in position to the groups. Processing is repeatedly executed to divide the selected groups into a predetermined number of groups each having an identical number of selection areas. Processing corresponding to an option displayed in the selection area and selected on a final selection screen is executed.

### CROSS-REFERENCE TO RELATED APPLICATIONS

This application is based upon and claims the benefit of priority from Japanese Patent Application No. 2007-166631, filed Jun. 25, 2007, the entire contents of which are incorporated herein by reference.

### BACKGROUND

1. Field

One embodiment of the invention relates to an information selection apparatus and an information selection method to have a desired option selected from many options displayed on a screen.

2. Description of the Related Art

As is widely known, an audio-visual (AV) device such as a TV broadcast receiving apparatus and an optical disk recording/reproducing device has an information selection function for execution of letter input, function selection, condition settings, adjustments of each part and the like. The information selection function usually makes many options displayed on a screen to allow a user to select a desired option therefrom.

In this case, in order to select an option, a cursor pointing to one option among many options displayed on the screen is usually caused to move to an intended option by selectively operating each key to cause the cursor to move up or down or move to the right or left to thereby move the cursor from one option to another among many options. Thus, the number of operations increases, leading to a long time required to reach the intended option.

Jpn. Pat. Appln. KOKAI Publication No. 2002-14773 discloses a configuration in which, when a pointer displayed on a screen is caused to move by key operations, the cursor is moved to any position on the screen with a smaller number of operations by dividing the screen into a predetermined number of screens and causing the pointer to move from each divided screen to one selected screen.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 shows an embodiment of the present invention and is a diagram shown for schematically illustrating a digital TV broadcast receiving apparatus and a network system centering thereon;

FIG. 2 is a block configuration diagram for illustrating a main signal processing system of the digital TV broadcast receiving apparatus in the embodiment;

FIG. 3 is an outline view for illustrating a remote controller of the digital TV broadcast receiving apparatus in the embodiment;

FIG. 4 is a diagram for illustrating one example of a letter input screen displayed on the digital TV broadcast receiving apparatus in the embodiment;

FIG. 5 is a diagram for illustrating one example of letter selection processing on the letter input screen displayed on the digital TV broadcast receiving apparatus in the embodiment;

FIG. 6 is a diagram for illustrating one example of letter selection processing on the letter input screen displayed on the digital TV broadcast receiving apparatus in the embodiment;

FIG. 7 is a diagram for illustrating one example of letter selection processing on the letter input screen displayed on the digital TV broadcast receiving apparatus in the embodiment;

FIG. 8 is a diagram for illustrating one example of a channel selection screen displayed on the digital TV broadcast receiving apparatus in the embodiment;

FIG. 9 is a diagram for illustrating one example of the channel selection screen displayed on the digital TV broadcast receiving apparatus in the embodiment;

FIG. 10 is a diagram for illustrating one example of the channel selection screen displayed on the digital TV broadcast receiving apparatus in the embodiment; and

FIG. 11 is a flow chart for illustrating one example of an information selection processing operation performed by the digital TV broadcast receiving apparatus in the embodiment.

### DETAILED DESCRIPTION

Various embodiments of the invention will be described hereinafter with reference to the accompanying drawings. In general, of one embodiment of the invention, an information selection screen including a plurality of selection areas is divided into a predetermined number of groups each having an identical number of selection areas. One group is selected from the divided groups by use of selection keys arranged to correspond in position to the groups. Processing is repeatedly executed to divide the selected groups into a predetermined number of groups each having an identical number of selection areas. Processing corresponding to an option displayed in the selection area and selected on a final selection screen is executed.

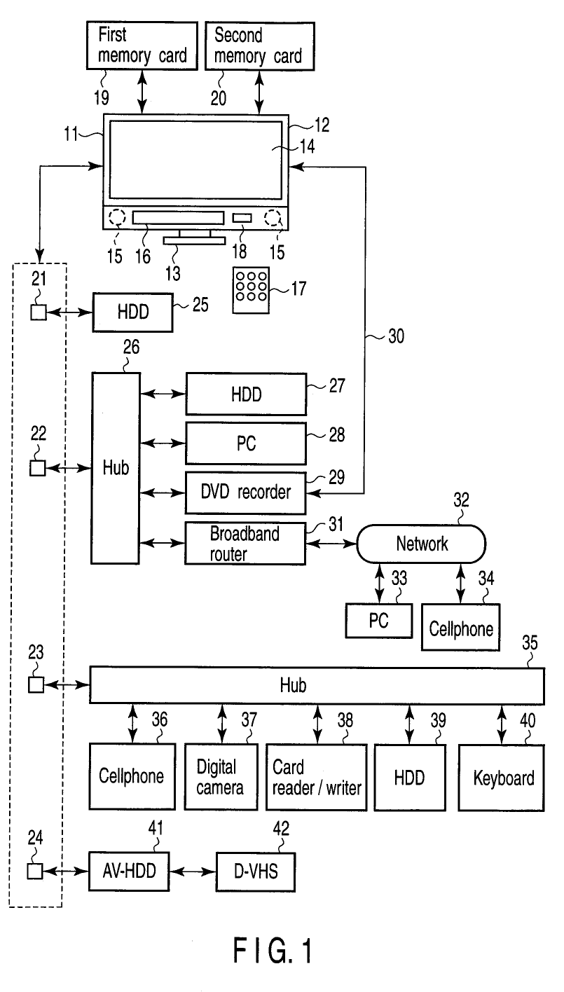

An embodiment of the present invention will be described in detail below with reference to the drawings. FIG. 1 schematically shows an appearance of a digital TV broadcast receiving apparatus 11 as an AV device illustrated in the present embodiment and an example of a network system configured centering on the digital TV broadcast receiving apparatus 11.

That is, the digital TV broadcast receiving apparatus 11 is mainly composed of a thin cabinet 12 and a support base 13 supporting the thin cabinet 12 in a standing position. In the cabinet 12, a flat panel image display unit 14 made of, for example, an SED (surface-conduction electron-emitter display) display panel or liquid crystal display panel, speakers 15, an operating part 16, a light sensing portion 18 receiving operation information transmitted from a remote controller 17 and the like are placed.

A first memory card 19 such as an Secure Digital (SD) memory card, multimedia card (MMC), and memory stick is removable from the digital TV broadcast receiving apparatus 11 and information such as programs and photos is recorded in and reproduced from the first memory card 19.

Further, a second memory card 20 (such as an integrated circuit [IC] card) in which, for example, contract information is recorded is removable from the digital TV broadcast receiving apparatus 11 and information is recorded in and reproduced from the second memory card 20.

The digital TV broadcast receiving apparatus 11 also includes a first local area network (LAN) terminal 21, a second LAN terminal 22, a Universal Serial Bus (USB) terminal 23, and an Institute of Electrical and Electronics Engineers (IEEE) 1394 terminal 24.

Among these terminals, the first LAN terminal 21 is used as a LAN-compliant HDD dedicated port. That is, the first LAN terminal 21 is used to record information in and reproduce information from a LAN-compliant HDD 25, which is network attached storage (NAS) connected thereto, via Ethernet (registered trademark).

By providing the first LAN terminal 21 as a LAN-compliant HDD dedicated port in the digital TV broadcast receiving apparatus 11, information of broadcast programs in HDTV quality can be stably recorded in the HDD 25 without any influence by other network environment or network use condition.

The second LAN terminal 22 is used as a general LAN-compliant port using Ethernet (registered trademark). That is, the second LAN terminal 22 is used to connect devices such as a LAN-compliant HDD 27, a personal computer (PC) 28, and a digital versatile disk (DVD) recorder 29 with a built-in HDD via a hub 26 to construct, for example, a home-wide network and to communicate information with these devices.

In this case, the PC 28 and the DVD recorder 29 each have a function to operate as a server device of content in a home-wide network and further, is configured as a universal plug and play (UPnP) compliant device having a service to provide uniform resource identifier (URI) information required for access to content.

For the DVD recorder 29, since digital information communicated via the second LAN terminal 22 is only control system information, a dedicated analog transmission path 30 is provided between the recorder 29 and the digital TV broadcast receiving apparatus 11 to transmit analog image and audio information therebetween.

Further, the second LAN terminal 22 is connected to an external network 32 such as the Internet via a broadband router 31 connected to the hub 26. Moreover, the second LAN terminal 22 is also used for information communication with a PC 33 and a cellphone 34 via the network 32.

The USB terminal 23 is used as a general USB-compliant port and connected to USB devices such as a cellphone 36, a digital camera 37, a card reader/writer 38 for memory cards, an HDD 39, and a keyboard 40 via a hub 35 to communicate information with these USB devices.

Further, the IEEE 1394 terminal 24 is used to serially connect a plurality of information recording/reproducing devices such as an AV-HDD 41 and a Digital Video Home System (D-VHS) videocassette recorder 42 to selectively communicate information with each device.

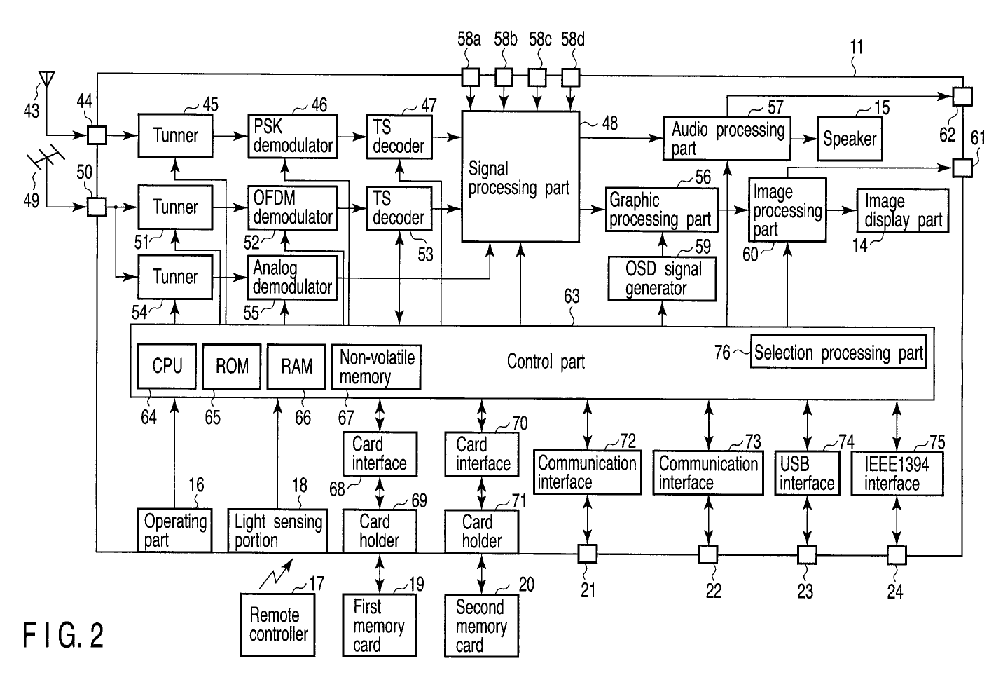

FIG. 2 shows a main signal processing system of the digital TV broadcast receiving apparatus 11. That is, a satellite digital TV broadcast signal received by an antenna 43 for direct broadcasting satellite (DBS) digital broadcast reception is fed to a digital DBS tuner 45 via an input terminal 44 so that a broadcast signal of a desired channel is tuned.

Then, the broadcast signal tuned by the tuner 45 is sequentially fed to a phase shift keying (PSK) demodulator 46 and a transport stream (TS) decoder 47 to be demodulated to a digital image signal and audio signal before being output to a signal processing part 48.

A terrestrial digital TV broadcast signal received by an antenna 49 for terrestrial broadcast reception is fed to a tuner 51 for terrestrial digital broadcasting via an input terminal 50 so that a broadcast signal of a desired channel is tuned.

Then, the broadcast signal tuned by the tuner 51 is sequentially fed, for example, in Japan to an orthogonal frequency division multiplexing (OFDM) demodulator 52 and a TS decoder 53 to be demodulated to a digital image signal and audio signal before being output to the signal processing part 48.

A terrestrial analog TV broadcast signal received by the antenna 49 for terrestrial broadcasting reception is fed to a tuner 54 for terrestrial analog broadcasting via the input terminal 50 so that a broadcast signal of a desired channel is tuned. Then, the broadcast signal tuned by the tuner 54 is fed to an analog demodulator 55 to be demodulated to an analog image signal and audio signal before being output to the signal processing part 48.

Here, the signal processing part 48 selectively performs predetermined digital signal processing on a digital image signal and a audio signal output from the TS decoders 47, 53 and outputs the processed digital image signal and audio signal to a graphic processing part 56 and a audio processing part 57 respectively.

A plurality (four in the illustration) of input terminals 58a, 58b, 58c, and 58d are connected to the signal processing part 48. These input terminals 58a to 58d each enable input of an analog image signal and audio signal from outside the digital TV broadcast receiving apparatus 11.

The signal processing part 48 selectively digitizes an analog image signal and audio signal each fed from the analog demodulator 55 and the input terminals 58a to 58d and performs predetermined digital signal processing on the digitized image signal and audio signal, which are then output to the graphic processing part 56 and the audio processing part 57, respectively.

The graphic processing part 56 has a function to superimpose an on-screen display (OSD) signal generated by an OSD signal generator 59 on a digital image signal fed from the signal processing part 48 and to output the superimposed signal. The graphic processing part 56 can selectively output an output image signal of the signal processing part 48 and an output OSD signal of the OSD signal generator 59, and also output both output signals by combining both so that each constitutes half the screen.

A digital image signal output from the graphic processing part 56 is fed to an image processing part 60. After converting an input digital image signal into an analog image signal in a format displayable in the image display unit 14, the image processing part 60 causes the image display unit 14 to display the analog image signal by outputting the signal to the image display unit 14 and also makes the analog image signal led out of the digital TV broadcast receiving apparatus 11 via an output terminal 61.

In addition, after converting an input digital audio signal into an analog audio signal in a format reproducible by the speaker 15, the audio processing part 57 causes the speaker 15 to reproduce the analog audio signal by outputting the signal to the speaker 15 and also makes the analog audio signal led out of the digital TV broadcast receiving apparatus 11 via an output terminal 62.

Here, the digital TV broadcast receiving apparatus 11 is controlled by a control part 63 in a unified fashion in all its operations including the above various receiving operations. The control part 63 incorporates a central processing unit (CPU) 64 and, after receiving operation information from the operating part 16 or that received by the light sensing portion 18 after being transmitted from the remote controller 17, controls each part so that operation content thereof is reflected in each part.

In this case, the control part 63 mainly uses a read-only memory (ROM) 65 in which a control program executed by the CPU 64 is stored, a random access memory (RAM) 66 providing a work area to the CPU 64, and a non-volatile memory 67 in which various kinds of setting and control information are stored.

The control part 63 is connected to a card holder 69 into which the first memory card 19 can be inserted via a card interface 68. Accordingly, the control part 63 can communicate information via the first memory card 19 inserted in the card holder 69 and the card interface 68.

Further, the control part 63 is connected to a card holder 71 into which the second memory card 20 can be inserted via a card interface 70. Accordingly, the control part 63 can communicate information via the second memory card 20 inserted in the card holder 71 and the card interface 70.

The control part 63 is also connected to the first LAN terminal 21 via a communication interface 72. Accordingly, the control part 63 can communicate information with the LAN-compliant HDD 25 connected to the first LAN terminal 21 via the communication interface 72. In this case, the control part 63 has a dynamic host configuration protocol (DHCP) server function and controls the LAN-compliant HDD 25 connected to the first LAN terminal 21 by allocating an IP (internet protocol) address to the LAN-compliant HDD 25.

Further, the control part 63 is connected to the second LAN terminal 22 via a communication interface 73. Accordingly, the control part 63 can communicate information with each device (see FIG. 1) connected to the second LAN terminal 22 via the communication interface 73.

The control part 63 is also connected to the USB terminal 23 via a USB interface 74. Accordingly, the control part 63 can communicate information with each device (see FIG. 1) connected to the USB terminal 23 via the USB interface 74.

Further, the control part 63 is connected to the IEEE 1394 terminal 24 via an IEEE 1394 interface 75. Accordingly, the control part 63 can communicate information with each device (see FIG. 1) connected to the IEEE 1394 terminal 24 via the IEEE 1394 interface 75.

Here, the control part 63 includes a selection processing part 76. That is, the digital TV broadcast receiving apparatus 11 has various setting modes prepared in advance to cause a user to perform, for example, letter input, channel tuning, function selection, condition settings, and adjustments of each part.

The selection processing part 76 controls a function, when the user selects one of the setting modes, to make many options prepared in advance for causing the user to select from in the selected setting mode displayed on the screen of the image display unit 14 to cause the user to select a desired option from these options.

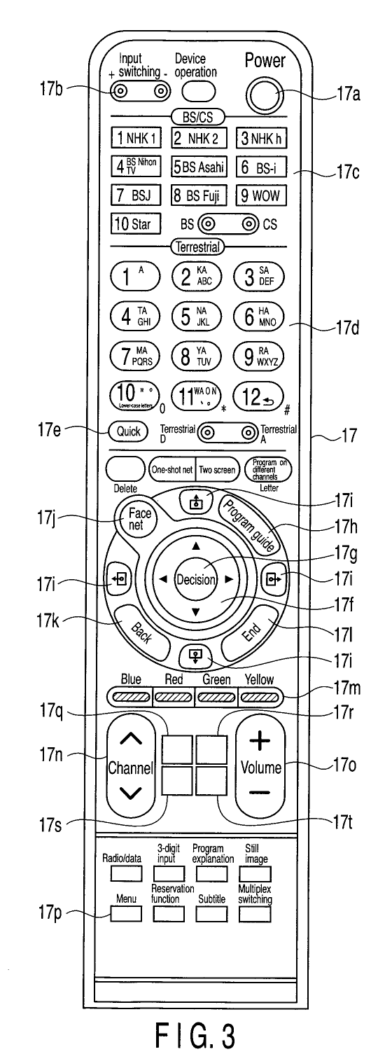

FIG. 3 shows an appearance of the remote controller 17. The remote controller 17 has mainly a power key 17a, an input switching key 17b, a direct tuning key 17c of satellite digital broadcast channels, a direct tuning key 17d of terrestrial broadcast channels, a quick key 17e, a cursor key 17f, a decision key 17g, a program guide key 17h, a page switching key 17i, a face-net (navigation) key 17j, a return key 17k, an end key 17l, a color key 17m of blue, red, green, and yellow, a channel up-and-down key 17n, a volume adjustment key 17o, and a menu key 17p provided thereon.

The remote controller 17 also has four selection keys 17q, 17r, 17s, and 17t arranged between the channel up-and-down key 17n and the volume adjustment key 17o. These selection keys 17q to 17t are arranged in a rectangular form in which two keys are aligned each horizontally and vertically when the operation side on which the keys 17a to 17t of the remote controller 17 are arranged is faced and viewed. In FIG. 3, the selection key 17q is arranged at the upper left, the selection key 17r at the upper right, the selection key 17s at the lower left, and the selection key 17t at the lower right.

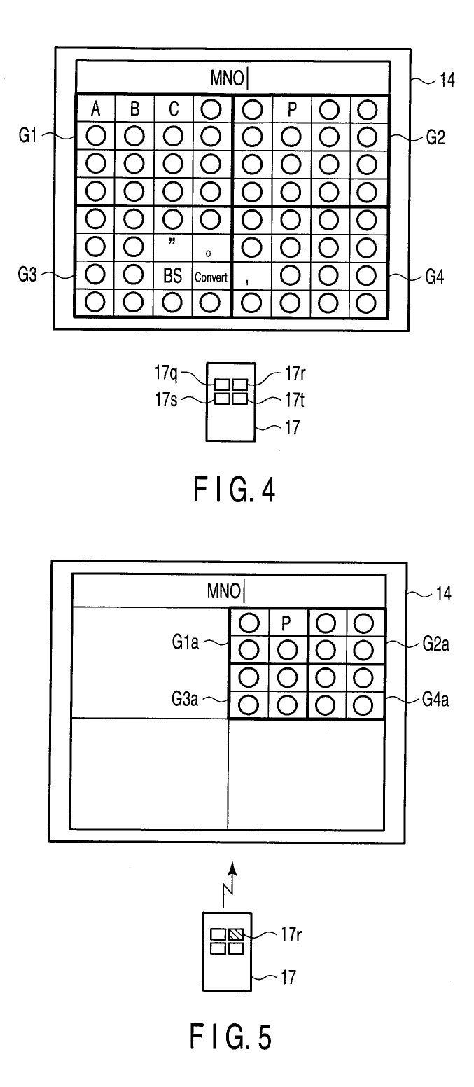

Here, a concrete example, in which a user is caused to select a desired option from many options displayed on the screen of the image display unit 14 in one setting mode selected by the user from the above various setting modes, will be described. FIG. 4 exemplifies a letter input screen displayed on the screen of the image display unit 14 when the setting mode for letter input is selected.

It is assumed that a user can select the setting mode by operating the menu key 17p of the remote controller 17 to sequentially make its way through menu screens in a hierarchical structure displayed on the screen of the image display unit 14 and reaching a desired setting mode.

That is, the letter input screen shown in FIG. 4 has eight (=2³) selection areas each horizontally and vertically, that is, 64 selection areas in total when the screen of the image display unit 14 is faced and viewed, and letters “A”, “B”, “C”, . . . to be an option are displayed in each selection area by associating with the selection area.

The selection areas having eight (=2³) areas each horizontally and vertically are divided, as shown by thick lines in FIG. 4, so that each group has four (=2²) areas each horizontally and vertically, that is, four groups G1, G2, G3, and G4 each having 16 selection areas. In this case, each group of G1 to G4 is arranged in a rectangular form in which two groups are aligned each horizontally and vertically. In FIG. 4, the group G1 is arranged at the upper left, the group G2 at the upper right, the group G3 at the lower left, and the group G4 at the lower right.

Accordingly, the arrangement of each group of G1 to G4 and that of the selection keys 17q to 17t of the remote controller 17 positionally correspond. That is, the group G1 and selection key 17q correspond, the group G2 and selection key 17r correspond, the group G3 and selection key 17s correspond, and the group G4 and selection key 17t correspond.

Here, a case in which a user enters a letter “P” when the letter input screen shown in FIG. 4 is displayed will be described. That is, the letter “P” the user wants to enter is contained in 16 selection areas constituting the group G2 on the letter input screen shown in FIG. 4.

Thus, as shown in FIG. 5, the user operates the selection key 17r corresponding to the group G2 among the selection keys 17q to 17t of the remote controller 17. Then, selection areas constituting the groups G1, G3, and G4 become invisible and 16 selection areas constituting the group G2 become visible on the letter input screen.

At this point, 16 selection areas constituting the group G2 are divided, as shown by thick lines in FIG. 5, so that each group has two (=2¹) areas each horizontally and vertically, that is, four groups G1a, G2a, G3a, and G4a each having four selection areas. Then, each group of G1a to G4a is arranged in a rectangular form in which two groups are aligned each horizontally and vertically. In FIG. 5, the group G1a is arranged at the upper left, the group G2a at the upper right, the group G3a at the lower left, and the group G4a at the lower right.

Accordingly, the arrangement of each group of G1a to G4a and that of the selection keys 17q to 17t of the remote controller 17 positionally correspond. That is, the group G1a and selection key 17q correspond, the group G2a and selection key 17r correspond, the group G3a and selection key 17s correspond, and the group G4a and selection key 17t correspond.

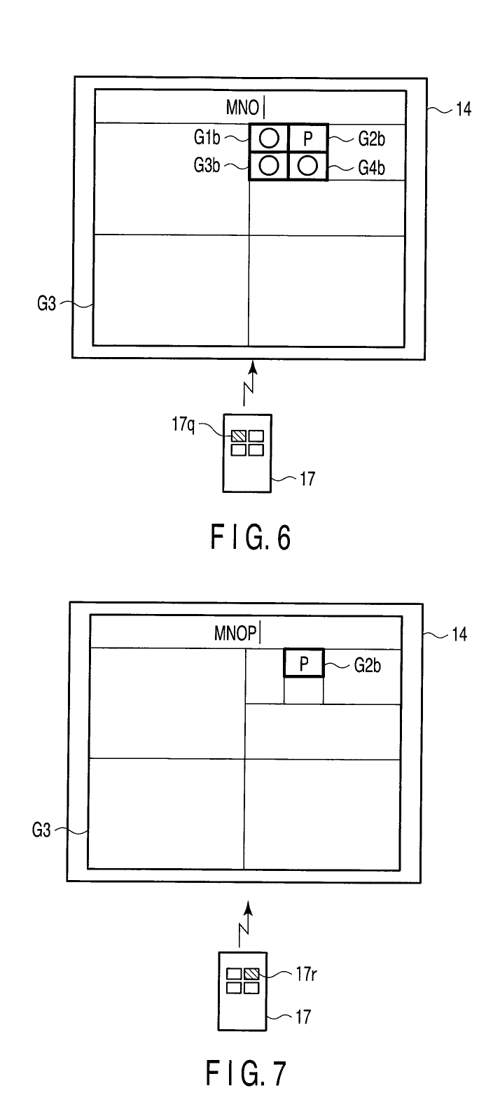

Then, the letter “P” the user wants to enter is contained in four selection areas constituting the group G1a on the letter input screen shown in FIG. 5. Thus, as shown in FIG. 6, the user operates the selection key 17q corresponding to the group G1a among the selection keys 17q to 17t of the remote controller 17. Then, selection areas constituting the groups G2, to G4a become invisible and four selection areas constituting the group G1a become visible on the letter input screen.

At this point, four selection areas constituting the group G1a are divided, as shown by thick lines in FIG. 6, so that each group has one (=2⁰) area horizontally and vertically, that is, four groups G1b, G2b, G3b, and G4b each having one selection area. Then, each group of G1b to G4b is arranged in a rectangular form in which two groups are aligned each horizontally and vertically. In FIG. 6, the group G1b is arranged at the upper left, the group G2b at the upper right, the group G3b at the lower left, and the group G4b at the lower right.

Accordingly, the arrangement of each group of G1b to G4b and that of the selection keys 17q to 17t of the remote controller 17 positionally correspond. That is, the group G1b and selection key 17q correspond, the group G2b and selection key 17r correspond, the group G3b and selection key 17s correspond, and the group G4b and selection key 17t correspond.

Then, the letter “P” the user wants to enter is contained in one selection area constituting the group G2b on the letter input screen shown in FIG. 6. Thus, as shown in FIG. 7, the user operates the selection key 17r corresponding to the group G2b among the selection keys 17q to 17t of the remote controller 17.

Here, as shown in FIG. 6, a state in which the groups G1b to G4b corresponding to the selection keys 17q to 17t of the remote controller 17 each contain only one letter (option) indicates a final selection screen and the group G2b (letter “P”) selected on the final selection screen will be entered as a letter.

Of the example described above, a letter input screen having eight (=2³) selection areas each horizontally and vertically is caused to be displayed on the screen, and the selection areas are divided into four groups G1 to G4, each having four (=2²) selection areas each horizontally and vertically. Then, each group of G1 to G4 is selected by using the selection keys 17q to 17t arranged on the remote controller 17 positionally associating with the groups G1 to G4 and the selected group is further divided into four groups G1a to G4a, each having two (=2¹) selection areas each horizontally and vertically. What has been described above is repeated to finally select a necessary option.

Thus, if the selection screen displayed first has 2ⁿ (n is a positive integer) selection areas each horizontally and vertically, that is, 2ⁿ×2ⁿ selection areas, a necessary option can be selected in the end by operating the selection keys 17q to 17t arranged on the remote controller 17 n times. Moreover, since four groups displayed on the screen and the selection keys 17q to 17t arranged on the remote controller 17 positionally correspond, selection operations can easily be performed without making a mistake. Accordingly, a desired option can be selected quickly and correctly with a smaller number of times of operation from many options displayed on the screen, making the embodiment sufficiently appropriate for practical use.

Further, the groups G1 to G4 to be selected are caused to be framed by thick lines on the letter input screen shown in FIG. 4 and therefore, a user can clearly distinguish the groups G1 to G4 containing a necessary option desired by the user, that is, the groups G1 to G4 to be selected, thereby allowing the user also in this respect to perform a correct selection operation without making a mistake. Instead of framing the groups G1 to G4 to be selected, each group of G1 to G4 may be color-coded and displayed.

On the other hand, as shown in FIG. 5, for example, when the specific group G2 is selected, lightness in display color of the other groups G1, G3, and G4 may be lowered than that of the group G2, instead of making the other groups G1, G3, and G4 invisible.

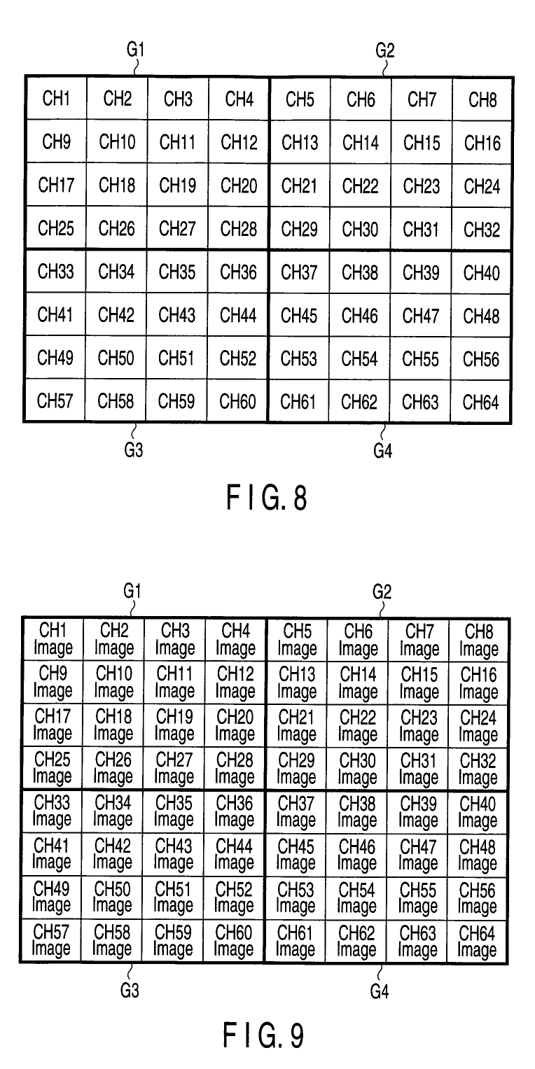

The above embodiment has described a case in which the setting mode for letter input is selected and, if the setting mode for channel tuning is selected, a channel tuning screen shown in FIG. 8 will be displayed on the screen of the image display unit 14. That is, the channel tuning screen shown in FIG. 8 has eight (=2³) selection areas each horizontally and vertically, that is, a total of 64 selection areas and channel numbers “CH1”, “CH2”, . . . to be an option are displayed in each selection area by associating with the selection area.

Then, the selection areas having eight (=2³) areas each horizontally and vertically are divided, as shown by thick lines in FIG. 8, so that each group has four (=2²) areas each horizontally and vertically, that is, four groups G1, G2, G3, and G4 each having 16 selection areas, and a desired group is selectable by the selection keys 17q to 17t of the remote controller 17.

Also, as shown in FIG. 9, a channel number and its actual broadcast content (images) may be displayed as an option in each of the selection areas having eight (=2³) areas each horizontally and vertically as the channel tuning screen. In this case, a display mode in which a display image with its channel number is OSD-displayed is practical.

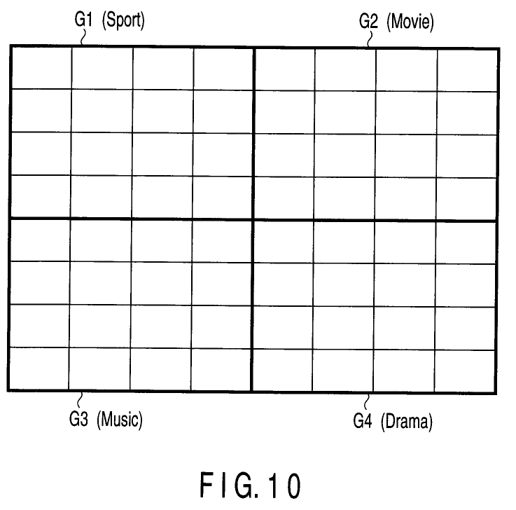

Further, as shown in FIG. 10, the selection areas having eight (=2³) areas each horizontally and vertically are divided into four groups G1, G2, G3, and G4, each having four (=2²) areas each horizontally and vertically as the channel tuning screen. Then, each group of G1 to G4 is caused to display channel numbers of programs corresponding to a genre specified by a user and their actual contents (images).

For example, sports programs are displayed in each selection area of the group G1, movie programs in each selection area of the group G2, music programs in each selection area of the group G3, and drama programs in each selection area of the group G4. Accordingly, a user can quickly search for programs the user wants to watch.

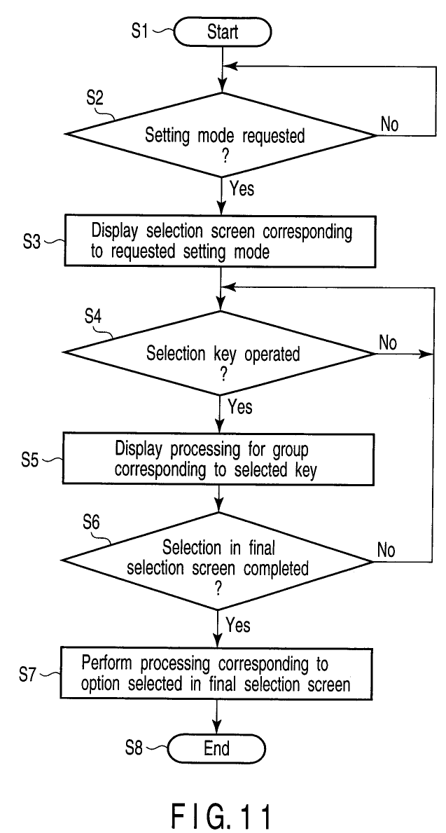

FIG. 11 shows a flow chart summarizing the above information selection processing operation. That is, when processing is started (step S1), the selection processing part 76 of the control part 63 determines whether any setting mode is requested at step S2 and, if determined that a setting mode has been requested (YES), the selection processing part 76 causes the image display unit 14 to display a selection screen corresponding to the requested setting mode at step S3.

The selection screen has, as described above, 2ⁿ selection areas each horizontally and vertically and each selection area is made to correspond to a concrete option. Then, all selection areas are divided into four groups, each group having 2ⁿ⁻¹ selection areas each horizontally and vertically.

The selection processing part 76 determines whether any of the selection keys 17q to 17t of the remote controller 17 is operated at step S4 and, if determined that a selection key has been operated (YES), the selection processing part 76 performs display processing for the group corresponding to the operated selection key 17q to 17t at step S5. The display processing includes making the selected group visible while making the other three groups invisible, selecting further four groups having equal numbers of selection areas horizontally and vertically from selection areas contained in the selected group and the like.

Subsequently, the selection processing part 76 determines whether a selection on the final selection screen is completed at step S6 and, if determined that the selection is not completed (NO), processing is returned to step S4. If determined that the selection on the final selection screen is completed at step S6 (YES), the selection processing part 76 performs processing corresponding to the option selected on the final selection screen at step S7 before terminating processing (step S8).

Here, in the embodiment described above, the digital TV broadcast receiving apparatus 11 is taken as an example of an AV device for which an information selection is made, but the present invention is not limited to this and the information selection function described in the above embodiment can naturally be applied, for example, to a recording/reproducing device for recording/reproducing groups of digital information in/from information recording media such as HDD and DVD. When applied to such a recording/reproducing device, modes to select viewing preselected programs and recording preselected programs will also be available.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information selection apparatus comprising:
a display part configured to display an information selection screen including a plurality of options;
an operation part including a plurality of selection keys which are arranged to correspond in position to the options included in the information selection screen; and
a control part configured to execute processing which corresponds to an option corresponding to an operated one of the selection keys.

2. The information selection apparatus according to claim 1, wherein:
the display part is configured to divisionally display an information selection screen having a plurality of selection areas such that the information selection screen is divided into a predetermined number of groups each having an identical number of selection areas; and
the operation part includes a predetermined number of selection keys which are arranged to correspond in position to the groups included in the information selection screen displayed by the display part.

3. The information selection apparatus according to claim 2, wherein:
the control part includes a processing part configured to divide the group corresponding to the selection key operated by the operation part into a predetermined number of groups each having an identical number of selection areas and to repeatedly execute processing that associates divided groups with the selection keys of the operation part; and
processing corresponding to an option displayed in the selection area and selected by operating the operating part is performed when a final selection screen is shown on which each of the groups obtained by the processing part includes only one selection area.

4. The information selection apparatus of claim 1, wherein the display part divisionally displays the information selection screen, in which a plurality of selection areas are arranged vertically and horizontally on a display screen, into a predetermined number of groups each including an identical number of selection areas.

5. The information selection apparatus of claim 1, wherein the display part divisionally displays the information selection screen, in which 2ⁿ selection areas (n: a positive number) are arranged vertically and horizontally on a display screen, into four groups each including 2ⁿ⁻¹ consecutive selection areas both horizontally and vertically.

6. The information selection apparatus of claim 2, wherein the display part displays the divided number of groups in a visually recognizable state by showing a frame on the display area or using different colors on the display area.

7. The information selection apparatus of claim 2, wherein the display part processes remaining groups which are included in the divided number of groups and unselected by the operation part, such that the remaining groups are not displayed or displayed with a display color brightness lower than that of the groups selected by the operation part.

8. The information selection apparatus of claim 1, wherein the display part is configured to display an information selection screen on which one of letter input, channel tuning and preselected program selection is performed.

9. The information selection apparatus of claim 1, wherein the operation part is configured to arrange a predetermined number of selection keys with respect to a remote controller.

10. An information selection method comprising:
displaying an information selection screen including a plurality of options;
operating one of selection keys which are arranged in position to correspond in position to the options included in the information selection screen; and
executing processing which corresponds to an option corresponding to an operated one of the selection keys.

11. The information selection method according to claim 10, wherein:
said displaying the information selection screen includes causing a display part to divisionally display an information selection screen having a plurality of selection areas, such that the information selection screen is divided into a predetermined number of groups each having an identical number of selection areas; and
said operating one of the selection keys includes causing an operation part, which includes a predetermined number of selection keys arranged to correspond in position to the groups included in the information selection screen displayed by the display part, to select one group from among the predetermined number of groups.

12. The information selection method according to claim 11, wherein:
said executing the processing includes dividing the group selected by the operation part into a predetermined number of groups each having an identical number of selection areas, and repeatedly executing processing that associates divided groups with the selection keys of the operation part; and
processing corresponding to an option displayed in the selection area and selected by operating the operating part is performed when a final selection screen is shown on which each of the groups corresponding to one of the selection keys of the operation part includes only one selection area.
